(19) United States
(12) Patent Application Publication
(10) Pub. No.: US 2006/0186100 A1
(43) Pub. Date: Aug. 24, 2006

(54) Device and procedure for the working of a surface of a transparent or translucent workpiece

(75) Inventor: Wilfried Philipp, Kornwestheim (DE)

Correspondence Address: HARNESS, DICKEY, & PIERCE, P.L.C, 7700 BONHOMME, STE 400, ST. LOUIS, MO, 63105, US

(73) Assignee: Tampoprint AG

(21) Appl. No.: 11/349,634

(22) Filed: Feb. 8, 2006

(30) Foreign Application Priority Data
Feb. 24, 2005 (DE) 102005009696.4-45

(51) Int. Cl. B23K 26/00; B23K 26/08

(52) U.S. Cl. 219/121.76; 219/121.82; 219/121.78

(57) ABSTRACT

The invention concerns a device for working a surface of a transparent or translucent workpiece by means of a laser beam, with a supporting table for the workpiece, a mounting plate for the laser, which emits laser beams, as well as a drive for the transport of the workpiece on the supporting table under the laser beam. In addition, the invention concerns a procedure for the working of such a device, whereby the workpiece is, in particular, continuously transported during working of the laser.

### CROSS-REFERENCE TO RELATED APPLICATION

This application claims the benefit of German Application Serial No. 10 2005 009 696.4-45, filed Feb. 24, 2005, titled “Device and Procedure for the Working of a Surface of a Transparent or Translucent Workpiece,” which is incorporated herein by reference.

### FIELD

The invention concerns a device for the working of a surface of a transparent or translucent workpiece by means of a laser beam. The invention also concerns a procedure for treating such a device.

### BACKGROUND

From DE 198 13 771 A1, a procedure for the manufacture of a glass tile is known, with which, on the back of the tile, a decoration layer is applied in laminar tiling fashion; a dominant mask of the pattern sample is applied on the decorative layer. Then, for example, the parts of the mask of the first decoration layer that are not covered by sandblasting, etching, or by means of a laser beam are not stripped. The manufacture of the mask in the form of a rubber mask, a plotter mask and the like is very intricate, and a separate mask must be made for each glass tile. In sandblasting, precautions must be taken in order to vacuum off the blasting abrasive and the work dust on the surface. In addition, sharp edges on the decor cannot be produced with this procedure. Waste products, which must be disposed of in an intricate fashion, are left over when the etching technique is employed. Only the use of a laser beam is environmentally sound, whereby the laser beam traverses the mask in an extensive manner, and only works on the surfaces that are not covered by the mask. A further disadvantage is seen in the fact that, with the sand blasting procedure, the radiated surface is matte and thus no longer transparent. Transparent, worked on surfaces are not able to be produced with the sandblasting procedure.

From DE 103 04 371 A1 a procedure for the working on of the surfaces of transparent materials by means of a laser beam has become known. Thus, the laser beam penetrates the material and encounters on its rear side an absorbing material, so that the energy of the laser beam is converted into thermal energy. Due to the contact between the surface of the workpiece which is to be worked and the plate constructed from absorbing material, a substantial part of the thermal energy is conveyed to the surface of the work piece to be treated. There, a local evaporation or melting of the smallest areas of the surface occurs. This procedure is, to be sure, substantially more environmentally sound than a sandblasting procedure or an etching procedure; however, due to the use of a plate constructed from absorbent material, it is not feasible on a large-scale basis.

There are also known devices with which plate-type products can be worked with a laser beam. The laser beam is deflected into displaceable optics, whereby the optics cab be directed in the direction of x and y. To be sure, vector images can be produced in this way. Since, however, the optics with their deflecting mirrors and the lens system exhibit a sizeable mass; only small accelerations and delays can be obtained. This device works in the manner of a type of plotter.

It is also known that the optics will only be displaced line by line. Thereby, only raster images can be produced, but the optics must be substantially accelerated and decelerated more rarely. This device works in the manner of a needle printer or inkjet printer. With both devices, surfaces of approximately 1200 mm×600 mm can be worked on in roughly an hour with the optics always standing over the point which is to be worked.

### SUMMARY

The invention has as its basic goal to make available a device and/or a procedure with which in a simple, inexpensive and quick fashion and manner, transparent or translucent workpieces can be worked by means of a laser beam.

This task is hereby solved with a device of the kind initially characterized, according to the invention, by the fact that a supporting table for the workpiece and a mounting plate for the laser, which emits laser beams, are proposed, as well as a drive for the transport of the workpiece on the supporting table under the laser beam.

With this device, according to invention, the workpiece must only be placed on the supporting table and transported under the laser beam, so that the laser beam can be trained on the workpiece. In this way, not only small sized but also large sized workpieces can be worked on with a single laser beam either holohedral or provided with a multiplicity of patterns.

In a further development, it is proposed that the mounting plate for the laser exhibits a carriage, which serves for the progress of the laser and/or as a means of deflection for the laser beam. On this carriage, either a laser is mounted, so that the laser, for example, can be displaced transverse to the transportation direction of the workpiece over the carriage. However, the possibility also exists, that the laser is mounted in a fixed position and, by means of the carriage, a means of deflection will only occur, for example, by a mirror. This has the advantage that substantially smaller masses must be moved, so that, on the one hand, higher speeds and accelerations can be realized, and, on the other hand, the carriage itself, as well as its drive, can be built smaller.

In a further development, the means of deflection is a scan system. Scan systems, which are also called recording head systems, possess two stored tiltable mirrors, over which the laser beam is diverted in the direction of the surface which is to be worked, i.e. the work area, without the scan system having to be displaced. The size of the work area amounts to, for example, 120 mm×120 mm. After this work area has been worked on, the scan system will proceed to neighboring work areas. It is possible that the tilt of the mirrors is without problems in the short term, since, thus, only very small masses must be moved.

As the mounting plate extends crosswise over the supporting table, it ensures that all areas of the workpiece can be covered by the laser beam. This also means, however, that with a displaceable laser, the scan system will proceed together with the laser. If the laser is stationary, then the laser beam is led, for example, by means of a light conductor to the scan system.

In a preferred example it is proposed that several lasers are arranged on the mounting plate. This has the substantial advantage that the work speed can be increased, since several lasers can work on the workpiece at the same time. Several lasers are favorably arranged over the entire width of the workpiece, whose work areas border on each other or even overlap.

In this way, wide patterns can be produced, as the edges of the partial patterns merge and flow into one another and are no longer recognizable. In addition, the entire width of the workpiece, which covers the work area of several lasers, can be completely covered with one on a carriage for the procedure of lasers or of a deflection means of a laser beam. The work areas can also be so arranged that the work areas are advanced in the transport direction one after the next, so that these work areas are temporarily transferred to the others. Overlaps of the work areas are, thus, more easily realized.

Since the use of several lasers can increase the work speed, the workpiece can be transported with a speed of 3 to 5 m/min, and the possibility exists that the device, according to the invention, is arranged as an inline device for a flat glass production plant. Thus, the drive for the workpieces can be a tape feed unit, a roll feed unit, or a table feed unit. The task initially specified is also solved with a procedure for operating a device with the characteristics specified above, whereby the workpiece is, in particular, continuously transported during laser processing. By transporting the workpiece during the laser processing, patterns can be produced, whose dimensions are larger than the ranges maximally attainable with a laser beam, i.e. larger than the working area of a laser. In addition, if the laser and/or a means of deflection for the laser beam is displaceable, turned around, respectively, only in transverse direction, mathematical curves can be produced, for example, Lissajou figures. The figure thus produced must not be computed in advance, rather through the activation of the drives.

According to a preferential example, the workpiece rests with the laser beam, in particular, worked in the form of a dot matrix. Thus, the points can exhibit the same or different sizes and; the distance between the points can be of various sizes (autotypical procedure). Another variant proposes that the workpiece is worked in the half-tone procedure. Finally, the working depth can vary, whereby three-dimensional pictures can be produced.

With the procedure, according to the invention, the workpiece can be provided with an endless pattern in both the longitudinal direction, as well as in the transverse direction. Thus, the edges of the pattern flow into one another and merge.

A further advantage is seen in the fact that, with the device, according to the invention, as well as the procedure outlined in the invention, the workpiece can be worked on its top side, which is either turned toward the laser or turned away from it. The workpiece can, therefore, be worked on in a work passage on both sides. Thus, the worked on surface can either be rough (matte) or smooth.

With the procedure, according to the invention, both genuine glass and acrylic glass can be treated, whereby the glass can also be dyed. If only the surface is dyed, then this surface, according to the invention, is worn away. Under this surface, another color is found, by which procedure described in the invention, a two-colored workpiece can be produced. The workpiece can also be worked with metals, plastic, wood and the like.

The procedure and device, according to the invention, are suitable, particularly for the working of flat workpieces, such as flat glass, doors, walls, room dividers, desk tops and the like, in particular, in industrial manufacturing and mass production. High speeds can be produced, since the masses, which can be moved, are negligibly small.

In a further development of the procedure according to the invention, the focus of the laser beam is directed at an area between the two surfaces, in particular the middle of the workpiece, so that the worked area remains enclosed in the workpiece and, furthermore, that the workpiece possesses intact surfaces.

Further advantages, characteristics and details of the invention result from the dependent claims, as well as from the following description, in which, with reference to the diagram, two particularly advantageous examples are described in detail. Thus, the mentioned characteristics can be, in each case, individually or in combination, essential for the invention represented in the diagram, as well as in the claims and description.

### DRAWINGS

The diagram shows:

FIG. 1, a perspective view of a first drawing of the invention with a laser; and

FIG. 2, a perspective view of a second drawing of the invention with several lasers.

### DETAILED DESCRIPTION

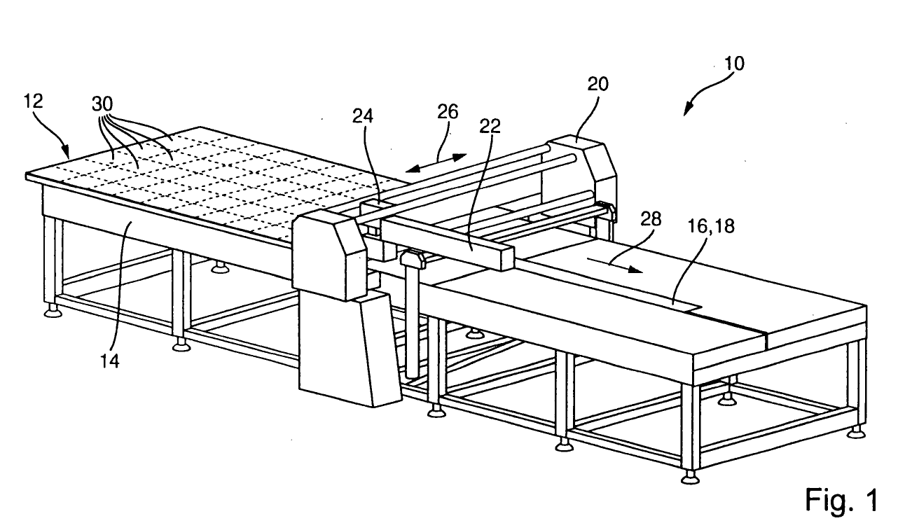

FIG. 1 shows an entire device for the working of a surface of a transparent workpiece 12, with 10 designations, which rests on a back end of a supporting table 14. This supporting table occupies, for example, a length of 6000 mm and a width of 1800 mm. At supporting table 14, a conveyor 16 is proposed, which serves as a drive 18 for workpiece 12. A mounting plate 20 extends crosswise over supporting table 14, on which a laser 22 is displaced on a carriage 24 in the direction of the double arrows 26. If workpiece 12 is passed through in the transportation direction 28 under mountain plate 20, then, in each case, a work area 30 is worked on workpiece 12 by means of a laser 22. On carriage 24, a scan system is situation with, for example, two mirrors, which can be rotated, with which the laser beam can be displaced, without offsetting laser 22 or mount 24 within work area 30. Thus, workpiece 12 can be passed through gradually or continuously under mount 24. In accordance with working on or finishing work area 30, laser 22 will proceed over carriage 24, and workpiece 12 will proceed by means of drive 18 to neighboring work area 30, which are so placed, so that work areas 30 of the laser beam border each other and/or overlap slightly. In this way, the entire surface of workpiece 12 can be worked with a single laser 22. If workpiece 12 is situated on the other side of supporting table 12, it can be removed from this with a suitable device.

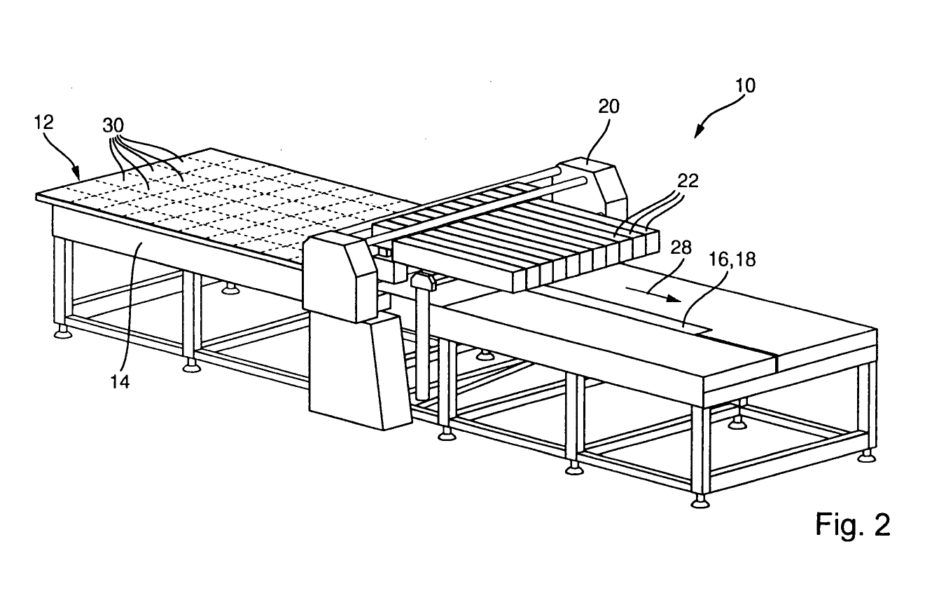

With the diagram of FIG. 2, several lasers 22, eleven altogether, are fastened to mounting plate 20, whereby these lasers 22 are not maneuverable over the carriage, but are rigidly fixed. The lasers 22 can be operated at the same time, so that they can work on all work areas 30, which lie next to each other, of workpiece 12 at the same time. Work areas 30 can also be alternated, i.e. shifted forwards and backwards, in transportation direction 28, so that the scan systems, which are likewise shifted forwards and backwards in transportation direction 29, do not mutually obstruct themselves. Workpiece 12 can, therefore, be continuously transported through under the mounting place 12, and, thus, is worked over its entire width. Also, with this diagram, work areas 30 border each other. The means of deflection for the laser beam can, however, also be adjusted, so that work areas 30 overlap in the boundary regions.

With drive 18, workpiece 12 can be moved, not only in the transportation direction 28, but also against this transportation direction 28, whereby mathematical curves, such as Lissajou figures can be produced. The device 10, which is represented in FIG. 2, can also be used as an inline device in a flat glass production plant. Thus, supporting table 14 is permanently equipped with workpieces 12, which are continuously withdrawn, after treatment, at the other end.

Workpieces 12 can be equipped, in each case, with the same patterns or program-controlled with different patterns, whereby the possibility also exists that each work area 30 exhibits another pattern. In addition, the patterns can be larger than a single work area 30 of a laser, and it can be engraved both on the top side pattern, as well as on the lower side pattern on the glass plate. In addition, in the area of mounting plate 20, a suction device is proposed, which suctions off dust, glass fragments, steam and the like that may result.

Such a device and procedure is not only environmentally sound, but also very flexible regarding the patterns which can be processed, which, for example, can be entered in the form of stored data into a steering control mechanism, which controls the laser. These patterns of data can also be given by the client or placed directly.

What is claimed is:

1. A device for processing a surface of a transparent or translucent workpiece by means of a laser beam with a supporting table for the workpiece, a mount for the laser emitting the laser beam, and a drive for transporting the workpiece on the supporting table under the laser beam, characterized in that multiple lasers are arranged in the mount, and that the multiple lasers are arranged next to each other and transverse to a direction of transport of the workpiece, wherein working areas of the multiple lasers are adjacent to each other or overlapping.

2. The device according to claim 1, characterized in that the mount for the laser comprises at least one of a slide for the laser and a deflection instrument for the laser beam.

3. The device according to claim 2, characterized in that the deflection instrument is a scanning or print head system.

4. The device according to claim 2, characterized in that the deflection instrument and the laser form one unit.

5. The device according to claim 2, characterized in that the slide can be displaced transversely to the direction of transport.

6. The device according to claim 1, characterized in that the mount extends transversely over the supporting table.

7. The device according to claim 1, characterized in that the working areas of the multiple lasers are arranged in front of each other in the direction of transport.

8. The device according to claim 1, characterized in that the device is an inline-device for a sheet glass production facility.

9. The device according to claim 1, characterized in that the drive for the transport of the workpiece is selected from a group consisting of a tape feed, roll feed, and a table feed.

10. A method for operating a device comprising multiple lasers arranged in a mount for processing a workpiece on a supporting table, the method comprising continuously transporting the workpiece on the supporting table and operating the multiple lasers simultaneously such that working areas of the multiple lasers adjoin each other or overlap.

11. The method according to claim 10, characterized in that the workpiece is rastered with the laser beam and is processed in the form of a dot matrix.

12. The method according to claim 10, characterized in that the workpiece is processed using a halftone method.

13. The method according to claim 10, characterized in that the workpiece is processed autotypically.

14. The method according to claim 10, characterized in that the workpiece is processed on a surface facing and/or facing away from the laser beam.

15. The method according to claim 10, characterized in that a working depth varies.

16. The method according to claim 10, characterized in that in a dot matrix rastering process is used wherein the dots have different sizes.

17. The method according to claim 10, characterized in that flat products such as sheet glass, doors, walls, room partitions, table tops and the like is/are being processed.

18. The method according to claim 10, characterized in that a deflection instrument can be displaced vertically to the supporting table.

19. The method according to claim 10, characterized in that glass or acrylic glass (plastic), wood, metals, or a combination thereof are being processed.
